(19) United States
(12) Patent Application Publication
(10) Pub. No.: US 2025/0220767 A1
(43) Pub. Date: Jul. 3, 2025

(54) USER DEVICE PERFORMING DISCONTINUOUS RECEPTION DURING RANDOM ACCESS IN WIRELESS COMMUNICATION SYSTEM, AND METHOD FOR OPERATING THE SAME

(71) Applicant: Samsung Electronics Co., Ltd., Suwon-si (KR)

(72) Inventors: SEUNGHUN YU, Suwon-si (KR); JONGGON LEE, Suwon-si (KR); SHICHANG RHO, Suwon-si (KR); KYU-SUK MO, Suwon-si (KR)

(21) Appl. No.: 18/948,603

(22) Filed: Nov. 15, 2024

(30) Foreign Application Priority Data
Dec. 29, 2023 (KR) 10-2023-0196209

(51) Int. Cl. H04W 76/28; H04W 52/02; H04W 74/0833; H04W 84/06

(52) U.S. Cl. CPC H04W 76/28; H04W 52/0229; H04W 74/0833; H04W 84/06

(57) ABSTRACT

A method of operating a user device wirelessly communicating with a non-terrestrial communication device includes transmitting a first message including a plurality of random access preambles to the non-terrestrial communication device, setting a power management device of the user device to a first discontinuous reception mode, during a first communication wait interval between a first time point, at which the last random access preamble among the plurality of random access preambles is transmitted, and a second time point at which a reception window interval starts, and receiving a second message corresponding to the first message from the non-terrestrial communication device, during the reception window interval.

### CROSS-REFERENCE TO RELATED APPLICATIONS

This application claims priority under 35 U.S.C. § 119 to Korean Patent Application No. 10-2023-0196209 filed on Dec. 29, 2023, in the Korean Intellectual Property Office, the disclosures of which are incorporated by reference herein in their entireties.

### BACKGROUND

Embodiments of the present disclosure described herein relate to a user device in a wireless communication system, and more particularly, relate to a user device performing discontinuous reception during random access in a wireless communication system and a method of operating the same.

A wireless communication system provides a variety of services, from voice service to data service, for a user while ensuring the activity of the user. Long Term Evolution (LTE) is one of wireless communication systems that provides high-speed services to users, and is a technology that implements high-speed packet-based communication having a data rate of up to about 100 Mps.

As smart electronic products and various uses of wireless communication devices are increasingly spread, the number of terminals performing wireless communication is increasing rapidly, and communication in various environments and various positions have been increasingly demanded. To this end, a non-terrestrial network (NTN) wirelessly connected to a core network on the non-terrestrial may be used, and the lifespan of the terminal needs to be extended by reducing the power consumption of the terminal placed in various environments and positions. The NTN refers to a communication network that extends beyond traditional ground-based infrastructures, incorporating space-based and airborne components such as satellites in various orbits (geostationary, medium Earth, and low Earth orbits), high-altitude platforms (such as balloons and drones), and potentially other aerial systems. The NTN serves to provide connectivity in remote, underserved, or hard-to-reach areas, enhance global coverage, and support various applications, including disaster recovery, maritime and aeronautical communication, and the Internet of Things (IoT).

### SUMMARY

Embodiments of the present disclosure provide a user device performing discontinuous reception in a wireless communication system and a method for operating the same.

According to an aspect of the present disclosure, a method of operating a user device wirelessly communicating with a non-terrestrial communication device, includes transmitting a first message including a plurality of random access preambles to the non-terrestrial communication device, setting a power management device of the user device to a first discontinuous reception mode, during a first communication wait interval between a first time point, at which the last random access preamble among the plurality of random access preambles is transmitted, and a second time point at which a reception window interval starts, and receiving a second message corresponding to the first message from the non-terrestrial communication device, during the reception window interval.

According to an aspect of the present disclosure, a user device of a non-terrestrial network system includes a power management device, a processor to generate a first message including a plurality of random access preambles, a transceiver to transmit the first message to a non-terrestrial communication device and to receive a second message corresponding to the first message from the non-terrestrial communication device. The processor sets the power management device to a first discontinuous reception mode, during a first communication wait interval between a first time point at which the transceiver transmits a last random access preamble among the plurality of random access preambles, and a second time point at which a reception window interval during which the transceiver is allowed to receive the second message starts.

According to an aspect of the present disclosure, a method for operating a non-terrestrial network system including a user device and a non-terrestrial communication device, includes transmitting, by the user device, a first message including a plurality of random access preambles to the non-terrestrial communication device, setting, by the user device, a power management device of the user device to a first discontinuous reception mode, during a first communication wait interval between a first time point, at which a last random access preamble among the plurality of random access preambles is transmitted, and a second time point at which a reception window interval starts, and transmitting, by the non-terrestrial communication device, the second message to the user device, such that the user device receives the second message corresponding to the first message during the reception window interval, through the non-terrestrial network.

### BRIEF DESCRIPTION OF THE FIGURES

The above and other objects and features of the present disclosure will become apparent by describing in detail embodiments thereof with reference to the accompanying drawings.

FIG. 1 is a view illustrating a non-terrestrial network system according to an embodiment of the present disclosure.

FIG. 2 is a flowchart illustrating a random access procedure of a typical non-terrestrial network system.

FIG. 3 is a view illustrating a random access procedure of a typical non-terrestrial network system.

FIG. 4 is a flowchart illustrating a random access procedure of a non-terrestrial network system according to some embodiments of the present disclosure.

FIG. 5 is a view illustrating the management of a first discontinuous reception mode according to some embodiments of the present disclosure.

FIG. 6 is a view illustrating a first sub-interval of FIG. 5, according to some embodiments of the present disclosure.

FIG. 7 is a view illustrating which a non-terrestrial network system manages a second discontinuous reception mode according to some embodiments of the present disclosure.

FIG. 8 is a block diagram illustrating a user device and a non-terrestrial communication device according to some embodiments of the present disclosure.

FIG. 9 is a flowchart illustrating a method for operating a user device according to some embodiments of the present disclosure.

### DETAILED DESCRIPTION

Hereinafter, embodiments of the present disclosure will be clearly described in detail to the extent that those skilled in the art easily reproduce embodiments of the present disclosure. In the following description, terminology for identifying a connection node, terminology for indicating a network entity, terminology for indicating messages, terminology for indicating the interface between network entities, or the terminology for indicating various pieces of identification information are provided for the illustrative purpose. Accordingly, the present disclosure is not limited to terminology to be described later, but another terminology may be used to indicate a component having the same technical meaning.

For the convenience of following explanation, terminology and names defined in the 3^{rd} Generation Partnership Project (3GPP), release 17, TS36.321 standard, and 3GPP, release 17, TS36.331, which are the latest standard among existing communication standards of the present disclosure, are used and is incorporated by reference. However, the present disclosure is not limited to such terminology and names, and the terminology and the names may be identically applied to systems according to different standards.

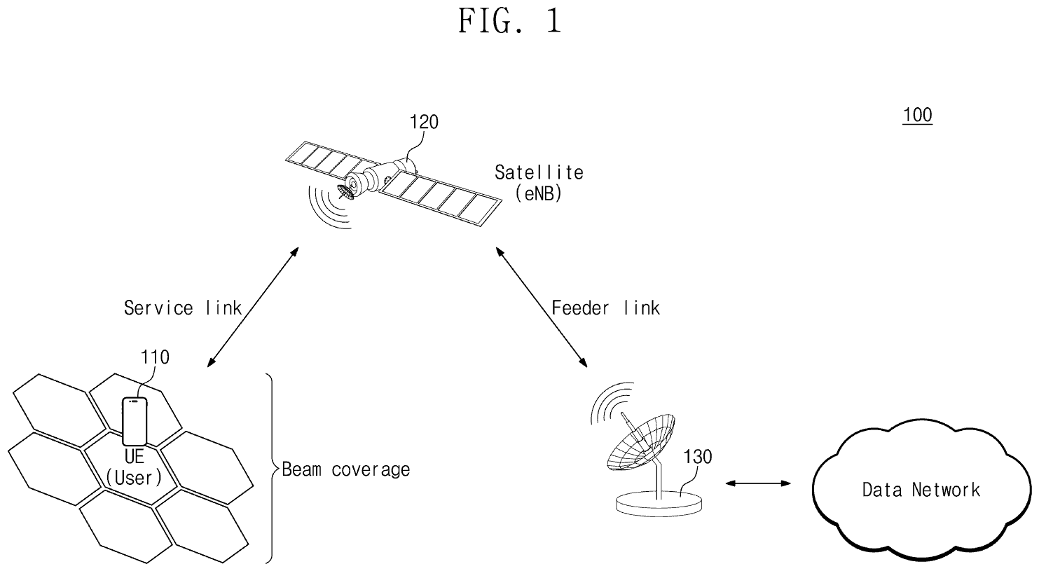

FIG. 1 is a view illustrating a non-terrestrial network system according to an embodiment of the present disclosure. A non-terrestrial network system 100 may indicate a wireless communication network system employing an unmanned aircraft system (UAS) platform floating in the air, instead of a base station on the ground.

According to some embodiments, the non-terrestrial network system 100 include a network or network segment using a radio frequency (RF) resource mounted on a satellite, or the UAS platform.

The non-terrestrial network system 100 may include a user device (or user equipment; UE) 110, a non-terrestrial communication device (evolved UTRAN node B; eNB) 120, and a satellite gateway 130.

The satellite gateway 130 may connect the non-terrestrial communication device 120 to a data network. Although one satellite gateway 130 is illustrated for convenience of explanation, the scope of the present disclosure is not limited thereto. For example, at least two satellite gateways 130 may be provided. The satellite gateway 130 may be connected to the non-terrestrial communication device 120 through a feeder link. The feeder link may be a radio link, which is a communication method that uses radio waves to transmit data between two or more points.

The non-terrestrial communication device 120 may be connected to the data network through the feeder link with the satellite gateway 130 on the ground. For example, the non-terrestrial communication device 120 may be a satellite. The non-terrestrial communication device 120 may transmit a beam for supporting RF resources to the ground through a service link. The service link may be a radio link. An area positioned on the ground to receive the beam transmitted from the non-terrestrial communication device 120 may be referred to as beam coverage. The non-terrestrial communication device 120 may provide a service to a user device (e.g., user equipment) included in the beam coverage, through the service link.

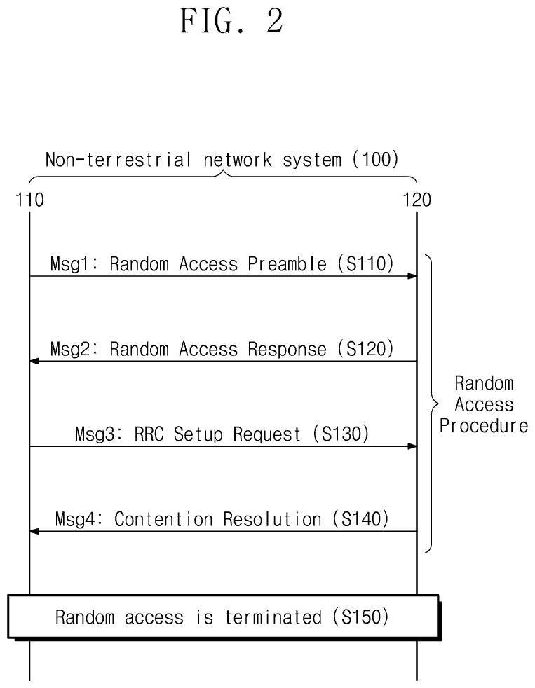

The user device 110 may be user equipment. The user device 110 included in the beam coverage of the non-terrestrial communication device 120 may receive a service from the non-terrestrial communication device 120 through the service link. The user device 110 may perform a random access procedure to access the data network through the non-terrestrial communication device 120. The random access procedure will be described with reference to FIG. 2 in more detail later.

FIG. 2 is a flowchart illustrating a random access procedure of a typical non-terrestrial network system 100. Referring to FIG. 2, a flowchart of the random access procedure of the non-terrestrial network system 100 is illustrated. The non-terrestrial network system 100 may correspond to the non-terrestrial network system 100 of FIG. 1, and may include the user device 110 and the non-terrestrial communication device 120. The random access operation in the 3GPP standard refers to the procedure that enables the user device 100 to establish a connection with the non-terrestrial communication device 120 under a communication protocol such as the 3GPP (3rd Generation Partnership Project) standard. The random access procedure may be involved in initial access, handover, and when a device needs to re-establish a connection after losing coverage. The random access operation may be categorized into two types: a content resolution based random access (CBRA) including all steps S110 to S140 as illustrated in FIG. 2, and a content resolution free random access (CFRA) including only steps S110 and S120 as illustrated in FIG. 2.

The user device 110 may perform the random access procedure to access the data network through the non-terrestrial communication device 120. For example, the user device 110 may perform the random access procedure for uplink synchronization with the non-terrestrial communication device 120 or for receiving RF resources from the non-terrestrial communication device 120.

In step S110, the user device 110 may transmit a first message Msg1 including a plurality of random access preambles to the non-terrestrial communication device 120.

Specifically, the user device 110 may select one random access preamble among several types of random access preambles. The user device 110 may select a channel for transmitting the random access preamble, based on a system information block (SIB) received from the non-terrestrial communication device 120. The SIB may contain information tailored to facilitate communication between the non-terrestrial communication device 120 and the user device 100. The information included in the SIB may include parameters for accessing and operating within a non-terrestrial network reflecting the unique characteristics of satellite communication, such as higher latency and different propagation conditions.

For example, the user device 110 may arbitrarily select a sub-frame, which is a position to transmit a random access preamble, and an index of a physical random access channel (PRACH). A random access-radio network temporal identifier (RA-RNTI) may be determined depending on the transmission position selected by the user device 110. The non-terrestrial communication device 120 may identify the transmission position of the random access preamble through the RA-RNTI. The user device 110 may transmit the random access preamble to the non-terrestrial communication device 120 through the selected PRACH.

In step S120, the non-terrestrial communication device 120 may transmit a second message Msg2 corresponding to the random access preamble, which is contained in the first message Msg1, to the user device 110. The second message Msg2 may include a random access response (RAR) signal.

For example, the random access response (RAR) signal may include a Random Access Preamble Identifier (RAPID) for identifying a plurality of random access preambles, UL (UpLink)-grant information, which is radio resource allocation information for transmitting a third message to be described later, a temporary identifier, and a temporary Cell-RNTI which is a temporary identifier assigned to the user device 110.

According to some embodiments, the non-terrestrial communication device 120 may multiplex random access response signals for the plurality of random access preambles identified through PRACHs into one second message Msg2. The non-terrestrial communication device 120 may transmit the second message Msg2 to the user device 110 through a physical downlink control channel (PDCCH).

In step S130, the user device 110 may transmit a third message Msg3 including a radio resource control (RRC) setup request signal to the non-terrestrial communication device 120, based on the second message Msg2.

The RRC setup request signal may be one of messages required for controlling a communication state between the user device 110 and the non-terrestrial communication device 120. When the user device 110 and the non-terrestrial communication device 120 is in a communication state of the RRC connection state through the RRC setup, the user device 110 may be allocated with RF resources from the non-terrestrial communication device 120.

Specifically, the user device 110 may check UL-grant information and temporary C-RNTI information included in the random access response signal. The user device 110 may transmit the third message Msg3 including an RRC connection setup request signal to the non-terrestrial communication device 120, based on the UL-grant information and the temporary C-RNTI information.

In step S140, the non-terrestrial communication device 120 may transmit a fourth message Msg4 corresponding to the third message Msg3, to the user device 110.

The non-terrestrial communication device 120 may allocate RF resources to the user device 110 based on the third message Msg3. In other words, the access of the user device 110 to the non-terrestrial communication device 120 may have succeeded. The non-terrestrial communication device 120 may transmit a fourth message Msg4, which includes a contention resolution signal indicating a successful connection to the user device 110, to the user device 110.

In step S150, the connection of the user device 110 to the non-terrestrial communication device 120 may be activated. In other words, the random access procedure of the user device 110 may be terminated because the connection of the user device 100 to the non-terrestrial communication device 120 is established.

For convenience of explanation, although the random access procedure of the user device 110 is illustrated in FIG. 2 to include a total of four steps S110 to S140, the scope of the present disclosure is not limited thereto. The user device 110 may access the non-terrestrial communication device 120 through steps S110 and S120 without steps S130 and S140 depending on the type of the random access procedure. For example, when the random access is a content resolution based random access (CBRA), the random access procedure may include all steps S110 to S140 as illustrated in FIG. 2. For an example, when the random access is a content resolution free random access (CFRA), the random access procedure may include only steps S110 and S120.

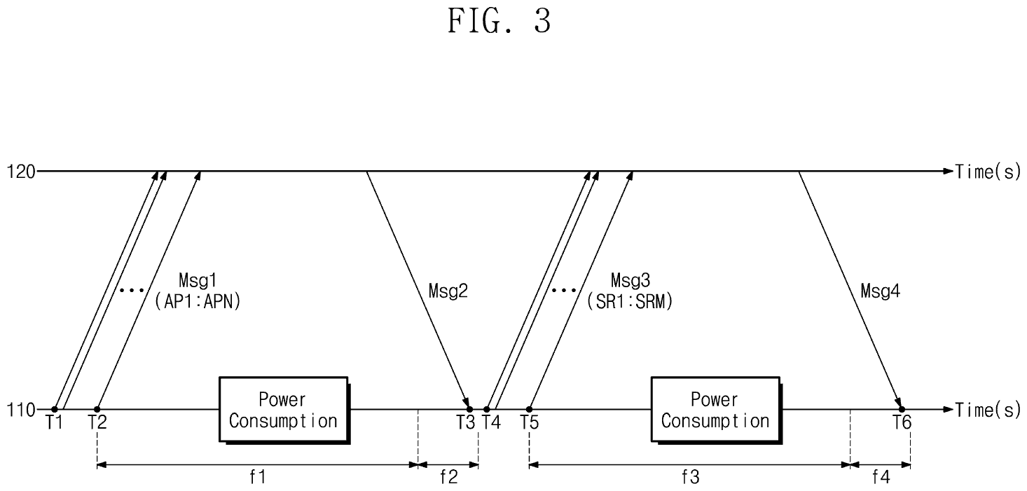

FIG. 3 is a view illustrating a random access procedure of the typical non-terrestrial network system. Hereinafter, a random access procedure of the typical non-terrestrial network system with the passage of time will be described with reference to FIG. 3. FIG. 3 illustrates transmission and reception of signals with the passage of time between the user device 110 and the non-terrestrial communication device 120 of FIG. 2, and a horizontal axis represents time.

Since a typical non-terrestrial network system uses the non-terrestrial communication device 120 as a base station, such as a satellite floating in the air instead of a base station on the ground, the distance between the user device 110 and the non-terrestrial communication device 120 may become longer compared to a base station on the ground. Accordingly, the time required for transmitting and receiving the signals between the user device 110 and the non-terrestrial communication device 120 may be longer, as compared to other network systems using a base station on the ground.

The user device 110 may start transmitting the first message Msg1 at a first time point T1. The first message Msg1 may include the N number of random access preambles. For example, the first message Msg1 may include a first random access preamble AP1 to an N-th random access preamble APN. The user device 110 may sequentially transmit the first random access preamble API to the N-th random access preamble APN to the non-terrestrial communication device 120. In other words, the user device 110 may transmit the first random access preamble AP1 to the non-terrestrial communication device 120 at the first time point T1.

Thereafter, the user device 110 may sequentially transmit the second random preamble AP2 to the N-th random preamble APN to the non-terrestrial communication device 120. A time point at which the user device 110 transmits the N-th random preamble APN to the non-terrestrial communication device 120 may be referred to as a second time point T2. In other words, the user device 110 may transmit the N-th random access preamble APN which is the last random access preamble of the N random access preambles, at the second time point T2.

The user device 110 may receive, from the non-terrestrial communication device 120, the second message Msg including a random access response (RAR) signal, at a third time point T3 which is an arbitrary time point during a second time interval f2 after a first time interval f1.

The first time interval f1 may be referred to as a first communication wait interval. The second time interval f2 may indicate a time interval for which the random access response signal is received. The second time interval f2 may also be referred to as a reception window interval. For example, the second time interval f2 may correspond to a random access response window defined in the 3GPP standard.

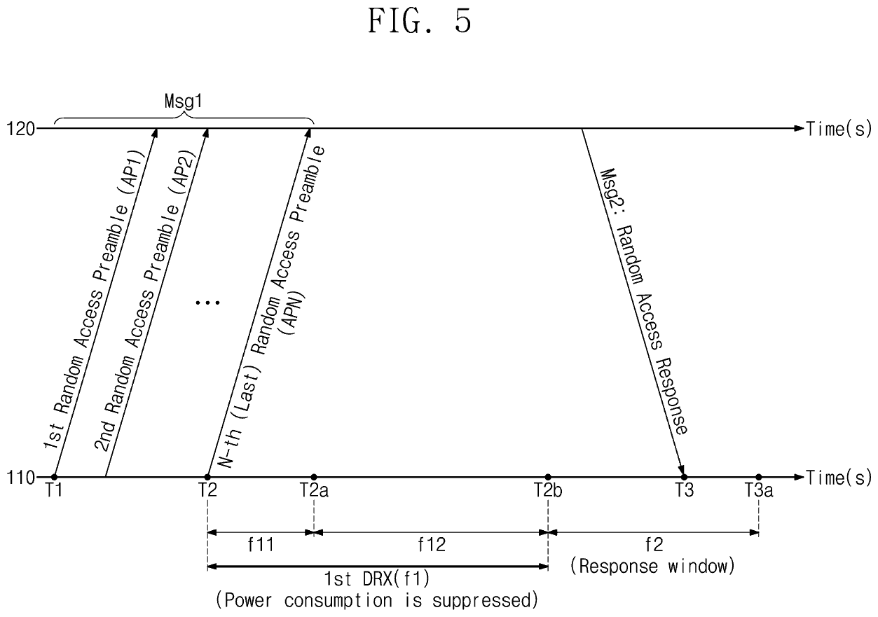

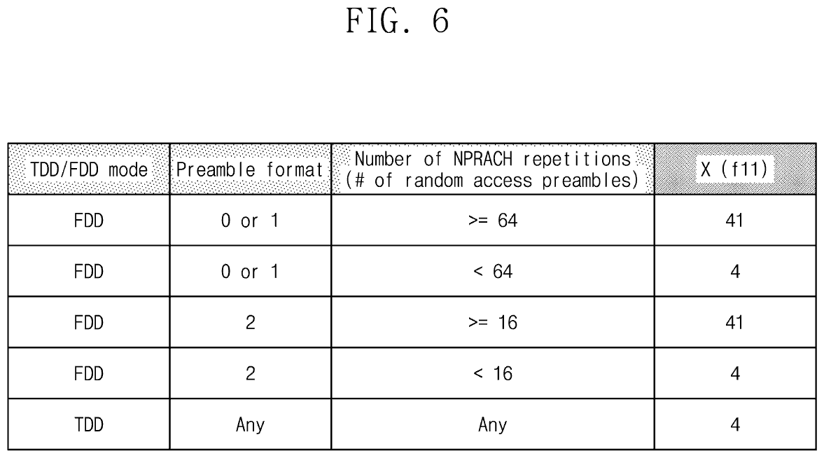

The first time interval f1 may indicate a time interval from a time point at which the N-th random access preamble APN which is the last random access preamble of the N random access preambles AP1 to APN, is transmitted to a time point at which the reception window interval, which is the second time interval f2, starts. The first time interval f1 will be described with reference to FIGS. 5 and 6 in more detail later.

The user device 110 may start transmitting the third message Msg3 including the M number of a plurality of RRC setup request signals SR1 to SRM at a fourth time point T4, after the second time interval f2 ends. In other words, the user device 110 may transmit the first RRC setup request signal SR1 to the non-terrestrial communication device 120 at the fourth time point T4. Thereafter, the user device 110 may sequentially transmit the second to M-th RRC transmission request signals SR2 to SRM to the non-terrestrial communication device 120. The user device 110 may transmit the M-th RRC setup request signal SRM, which corresponds to the last RRC setup request signal of the plurality of RRC set request signals SR1 to SRM, to the non-terrestrial communication device 120, at a fifth time point T5.

The user device 110 may receive the fourth message Msg4 including the competition resolution signal from the non-terrestrial communication device 120, at a sixth time point T6 which is an arbitrary time point during the fourth time interval f4, after passing the third time interval f3.

The third time interval f3 may be referred to as a second communication wait interval. The fourth time interval f4 may indicate a time interval in which a contention resolution signal is received. The fourth time interval f4 may be referred to as a time interval for a contention resolution time. For example, the fourth time interval f4 may correspond to the contention resolution time defined in the 3GPP standard.

The third time interval f3 may indicate a time interval from a time point at which the Mt-h RRC setup request signal SRM, which is the last RRC setup request signal among the M number of RRC setup request signals SR1 to SRM, is transmitted to a time point at which a contention resolution time interval, which is the fourth time interval f4, starts. The third time interval f3 will be described with reference to FIG. 56 in more detail later.

The user device 110 of a typical non-terrestrial network system may consume unnecessary power for the first time interval f1 and the third time interval f3. For example, for the first time interval f1 and the third time interval f3, the user device 110 may monitor reception of the arbitrary signal from the non-terrestrial communication device 120.

In detail, the user device 110 may consume power to monitor the second message Msg2 for the first time interval f1. The user device 110 may consume power to monitor the fourth message Msg4 for the third time interval f3.

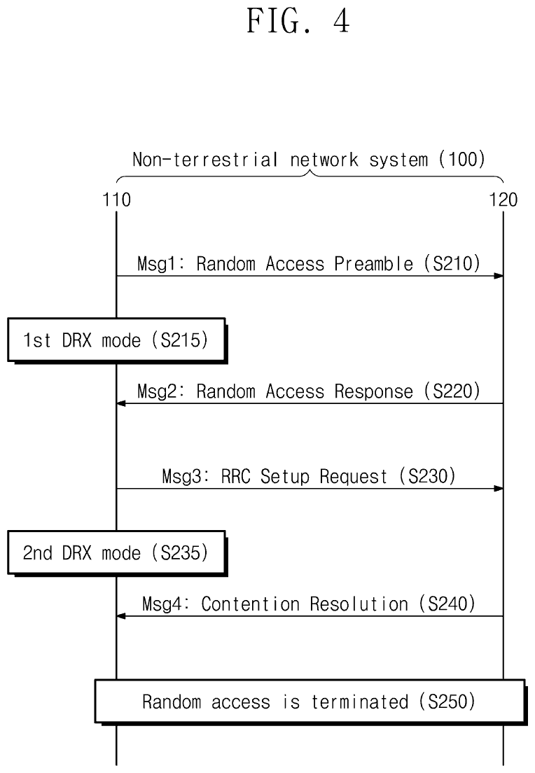

FIG. 4 is a flowchart illustrating the random access procedure of the non-terrestrial network system 100 according to some embodiments of the present disclosure. Hereinafter, the random access procedure of the non-terrestrial network system 100 will be described with reference to FIG. 4. The non-terrestrial network system 100 of FIG. 4 may correspond to the non-terrestrial network system 100 of FIG. 1. The non-terrestrial network system 100 may include the user device 110 and the non-terrestrial communication device 120.

In the following description about the random access procedure of FIG. 4, the duplication of FIG. 2 will be briefly described or omitted below, for convenience of explanation.

In step S210, the user device 110 may transmit the first message Msg1 including the plurality of random access preambles to the non-terrestrial communication device 120.

In step S215, the user device 110 may set a power management device of the user device 110 to a first discontinuous reception DRX1) mode.

For example, the user device 110 may set the power management device to the first discontinuous reception (DRX1) mode during the first communication wait interval between the time point at which the last random access preamble among the plurality of random access preambles is transmitted and the time point at which the reception window interval starts.

According to some embodiments, when the power management device is set to the first discontinuous reception (DRX1) mode, the user device 110 may not receive an arbitrary signal from the non-terrestrial communication device 120 or transmit an arbitrary signal to the non-terrestrial communication device 120. For example, the user device 110 may not monitor the second message Msg2 from the non-terrestrial communication device 120. In other words, the user device 110 may not monitor a PDCCH. The details thereof will be described later with reference to FIG. 5.

According to some embodiments, when the power management device is set to the first discontinuous reception (DRX1) mode, the user device 110 may perform a discontinuous reception (DRX) operation defined in the 3GPP standard.

In step S220, the non-terrestrial communication device 120 may transmit the second message Msg2 to the user device 110. The second message Msg2 may correspond to the first message Msg1 and may include the random access response signal.

For example, the non-terrestrial communication device 120 may transmit the second message Msg2 to the user device 110, such that the user device 110 receives the second message Msg2 during the reception window interval. In other words, the user device 110 may receive the second message Msg2 at an arbitrary time point during the reception window interval.

In step S230, the user device 110 may transmit the third message Msg3 to the non-terrestrial communication device 120 based on the second message Msg2. The third message Msg3 may include a plurality of RRC setup request signals.

In step S235, the user device 110 may set the power management device of the user device 110 to a second discontinuous reception (DRX2) mode.

For example, the user device 110 may set the power management device to the second DRX2 mode during the second communication wait interval between the time point at which the last RRC setup request signal among the plurality of RRC setup request signals is transmitted and the time point at which the contention resolution time interval starts.

According to some embodiments, when the power management device is set to the second DRX2 mode, the user device 110 may not receive an arbitrary signal from the non-terrestrial communication device 120 or transmit the arbitrary signal to the non-terrestrial communication device 120. For example, the user device 110 may not monitor a fourth message Msg4. In other words, the user device 110 may not monitor the PDCCH. The details thereof will be described later with reference to FIG. 5.

According to some embodiments, when the power management device is set to the second discontinuous reception (DRX2) mode, the user device 110 may perform the DRX (discontinuous reception) operation defined in the 3GPP standard.

In step S240, the non-terrestrial communication device 120 may transmit the fourth message Msg4 to the user device 110. The fourth message Msg4 may correspond to the third message Msg3 and may include a contention resolution signal. The non-terrestrial communication device 120 may transmit the fourth message Msg4 to the user device 110 such that the user device 110 may receive the fourth message Msg4 during a contention resolve timer interval. In other words, the user device 110 may receive the fourth message Msg4 during the contention resolve timer interval.

In step S250, random access between the user device 110 and the non-terrestrial communication device 120 may be terminated (i.e., successful), and the connection of the user device 110 to the non-terrestrial communication device 120 may be activated.

For convenience of explanation, although the random access procedure including steps S210 to S240 has been described, the scope of the present disclosure is not limited thereto. For example, in the random access procedure of a CFRA including only steps S210 to S220, the user device 110 may set the power management device only to the first discontinuous reception (DRX1) mode. Specifically, the user device 110 may determine whether to set only the first discontinuous reception (DRX1) mode depending on the type of random access (e.g., CBRA or CFRA), as in step S215, or determine whether to set the first discontinuous reception (DRX1) mode in step S215, and to set the second discontinuous reception (DRX2) mode in step S235.

In the non-terrestrial network system 100 according to an embodiment of the present disclosure, the user device 110 may manage the power management device in a discontinuous reception mode during some intervals in the random access procedure. Accordingly, the user device 110 may not consume unnecessary power by preventing a monitoring operation for arbitrary signals during some sections. In other words, the user device 110 may suppress power consumption for the random access time interval and may increase the lifespan of the user device 110.

FIG. 5 is a view illustrating a flowchart in which a non-terrestrial network system manages the first discontinuous reception (DRX1) mode according to some embodiments of the present disclosure. The following description will be made with reference to FIG. 5 regarding the first discontinuous reception (DRX1) mode in the random access procedure. Specifically, FIG. 5 illustrates transmission and reception of various signals between the user device 110 and the non-terrestrial communication device 120 over time, and the horizontal axis represents time. The user device 110 and the non-terrestrial communication device 120 of FIG. 5 correspond to the user device 110 and the non-terrestrial communication device 120 of FIG. 4, respectively.

The user device 110 may transmit a first random access preamble AP1 among the N number of random access preambles AP1 to APN which are included in the first message Msg1 to the non-terrestrial communication device 120 at the first time point T1. Thereafter, the user device 110 may sequentially transmit the second random access preamble AP2 to the N-th random access preamble APN, to the non-terrestrial communication device 120. The user device 110 may transmit the N-th random access preamble APN, corresponding to the last random access preamble of the N number of random access preambles AP1 to APN, to the non-terrestrial communication device 120 at the second time point T2.

The user device 110 may set the power management device to the first discontinuous reception (DRX1) mode during the first time interval f1. In other words, the user device 110 may perform a discontinuous reception operation under the control of the power management device, for the first time interval f1.

The discontinuous reception operation may indicate that the user device 110 does not transmit an arbitrary signal to the non-terrestrial communication device 120 and does not receive the arbitrary signal from the non-terrestrial communication device 120 during a sleep interval. The sleep interval may be less than or equal to the first time interval f1. For example, the sleep interval may be at least a part of the first time interval f1. Accordingly, the user device 100 may consume less power during the discontinuous reception operation, as compared to when the discontinuous reception operation is not performed.

For example, the user device 110 may not monitor the second message Msg2 during the sleep interval. Monitoring of the second message Msg2 may indicate monitoring of the PDCCH.

According to some embodiments, a discontinuous reception operation may include at least one discontinuous reception cycle. In other words, the first time interval f1 may include at least one discontinuous reception cycle. One discontinuous reception cycle may include a drx-onDuration timer interval and the sleep interval. When the user device 110 does not receive any signal from the non-terrestrial communication device 120 during the drx-onDuration timer interval, the user device 110 may not receive any signal from the non-terrestrial communication device 120 or may not transmit any signal to the non-terrestrial communication device 120 during the sleep interval.

According to some embodiments, the DRX operation described above may correspond to a DRX operation defined in the 3GPP standard. Also, the drx-onDuration timer interval may correspond to a ‘drx-onDuration timer interval’ defined in the 3GPP standard.

Hereinafter, the first time interval f1 in which the user device 110 may perform the DRX operation will be described in more detail.

The first time interval f1 may include a first sub-interval f11 and a second sub-interval f12. The first sub-interval f11 refers to a time interval between the second time point T2 and a 2a-th time point T2a. The first sub-interval f11 may be determined based on random access preambles AP included in the first message Msg1. More specifically, it is determined based on the format and number (i.e., the number of transmissions) of the random access preambles AP. The first sub-interval f11 will be described with reference to FIG. 6 in more detail later.

The second sub-interval f12 may refer to a time interval between the 2a-th time point T2a and a 2b-th time point T2b. The second sub-interval f12 may indicate a round trip time interval between the user device 110 and the non-terrestrial communication device 120. Specifically, the second sub-interval f12 may be determined based on a time required to transmit the first message Msg1 from the user device 110 to the non-terrestrial communication device 120 and a time required to transmit the second message Msg2 from the non-terrestrial communication device 120 to the user device 110. Since the non-terrestrial communication system has a long distance between the user device 110 and the non-terrestrial communication device 120, a time required for the user device 110 to transmit the first message Msg1 and receive a response signal (e.g., the second message Msg2) corresponding to the first message Msg1 may be considered as a time interval for performing the discontinuous reception operation.

According to some embodiments, the second sub-interval f12 may correspond to ‘UE-eNB-RTT (round trip time)’ defined in the 3GPP standard.

According to some embodiments, the second sub-interval f12 may be determined based on a correction time based on a distance between the user device 110 and the non-terrestrial communication device 120. For example, the second sub-interval f12 is determined based on a first correction time and a second correction time. Specifically, the second sub-interval f12 may be the sum of the first correction time and the second correction time.

The first correction time may correspond to an offset for mitigating the propagation delay between the user device 110 and the non-terrestrial communication device 120. The offset may also be referred to as a timing advance. Specifically, the first correction time may indicate an adjustment amount of timing to be applied to the user device 110, to synchronize the uplink and the downlink between the user device 110 and the non-terrestrial communication device 120.

For example, the timing advance may correspond to the timing advance during random access defined in the 3GPP standard.

The second correction time may correspond to an offset for mitigating a data frame difference between the uplink and the downlink between the user device 110 and the non-terrestrial communication device 120. Specifically, when a difference is made between a first data frame in the uplink and a second data frame in the downlink, the non-terrestrial network system may adjust transmission timing between the user device 110 and the non-terrestrial communication device 120 based on the difference between the first data frame in the uplink and the second data frame in the downlink.

For example, the second correction time may correspond to ‘k-mac’ defined in the 3GPP standard.

According to some embodiments, the second sub-interval f12 may be longer than the first sub-interval f11.

The user device 110 may receive the second message Msg2 from the non-terrestrial communication device 120 at the third time point T3 which is an arbitrary time point during the second time interval f2. The second message Msg2 may include the random access response signal.

The second time interval f2 may indicate a time interval between the 2b-th time point T2b and a 3a-th time point T3a. The second time interval f2 is a time interval for receiving the second message Msg2 and may also be referred to as the reception window interval.

According to some embodiments, the second time interval f2 may correspond to a random access response window size defined in the 3GPP standard.

FIG. 6 is a view illustrating the first sub-interval f11 of FIG. 5, according to some embodiments of the present disclosure. Hereinafter, the first sub-interval f11 will be described with reference to FIG. 6.

The first sub-interval f11 may be included in the first time interval f1 in which the user device 110 of FIG. 5 may set the power management device to the first discontinuous reception (DRX1) mode. The first sub-interval f11 may be determined based on a random access preamble included in the first message Msg1. For example, the first sub-interval f11 may be determined based on the format and number of random access preambles (e.g., the number of transmissions).

In more detail, the first sub-interval f11 may be determined based on a preamble format of a random access preamble, the number of random access preambles, and a communication scheme between the user device and the non-terrestrial communication device. The communication scheme between the user device and the non-terrestrial communication device may be one of a time division duplex (TDD) mode and a frequency division duplex (FDD) mode. The details of the TDD mode or the FDD mode will be made later.

According to some embodiments, the first sub-interval f11 may correspond to a variable ‘X’ for improved coverage defined in the 3GPP standard.

First, a TDD/FDD mode of the communication scheme will be described in detail below.

When the communication scheme is the TDD mode, the user device and the non-terrestrial communication device use all bands of the frequency in each of the uplink and the downlink, but may be used by dividing time. The uplink may indicate a transmission link from the user device to the non-terrestrial communication device, and the downlink may indicate a transmission link from the non-terrestrial communication device to the user device. In the TDD mode, since time is divided for use, data transmission in each of the uplink and the downlink may not be performed simultaneously.

When the communication scheme is the FDD mode, the user device and the non-terrestrial communication device may divide frequency bands for use in each of the uplink and the downlink. Accordingly, the frequency bands in the uplink and the downlink may be divided and transmitted simultaneously.

According to some embodiments, the TDD mode and the FDD mode may correspond to the TDD mode and the FDD mode defined in the 3GPP standard, respectively.

The preamble format may indicate an index according to a format of a random access preamble transmitted from the user device to the non-terrestrial communication device in the non-terrestrial network system. For example, the preamble format may represent one of 0, 1, 2, 3, and 4. According to the preamble format, the lengths of elements forming the random access preamble may be determined. For example, according to the preamble format of the random access preamble, the length of a cyclic prefix of the random access preamble and the length of the remaining portion may be determined. For example, the numbers of the preamble format may represent the length of the cyclic prefix of the random access preamble and the length of the remaining portion.

According to some embodiments, the preamble format may correspond to a preamble format defined in the 3GPP standard.

The number of random access preambles represents the number of random access preambles included in the first message Msg1. According to some embodiments, the number of random access preambles may correspond to the number of repetitions of a narrowband physical random access channel (NPRACH) defined in the 3GPP standard.

The first sub-interval f11 is determined based on a TDD/FDD mode, a preamble format, and the number of random access preambles.

For example, when the user device of the non-terrestrial network system is set in the FDD mode, the preamble format is ‘0’ or ‘1’, and the number of random access preambles transmitted to the non-terrestrial communication device is ‘64’ or more, the length of the first sub-interval f11 is 41 millisecond (ms).

For example, when the user device of the non-terrestrial network system is set in the FDD mode, the preamble format is ‘0’ or ‘1’, and the number of random access preambles transmitted to the non-terrestrial communication device is less than ‘64’, the length of the first sub-interval f11 is 4 ms.

For example, when the user device of the non-terrestrial network system is set in the FDD mode, the preamble format is ‘2’, and the number of random access preambles transmitted to the non-terrestrial communication device is ‘16’ or more, the length of the first sub-interval f11 is 41 ms.

For example, when the user device of the non-terrestrial network system is set in the FDD mode, the preamble format is ‘2’, and the number of random access preambles transmitted to the non-terrestrial communication device is less than ‘16’, the length of the first sub-interval f11 is 4 ms.

For example, when the user device of the non-terrestrial network system is set in the TDD mode, the length of the first sub-interval f11 is 4 ms, regardless of the number of random access preambles transmitted to the non-terrestrial communication device.

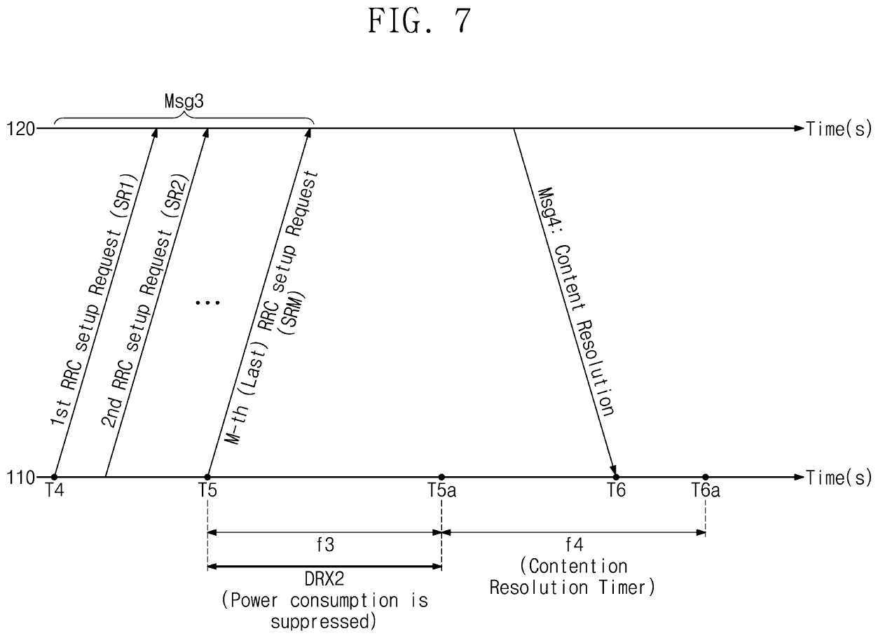

FIG. 7 is a view illustrating a non-terrestrial network system managing a second discontinuous reception mode according to some embodiments of the present disclosure. The following description will be made with reference to FIG. 7, regarding the second discontinuous reception (DRX2) mode during the random access process. Specifically, FIG. 7 illustrates the transmission and the reception of several signals between the user device 110 and the non-terrestrial communication device 120 with the passage of time, and a horizontal axis indicates time. The user device 110 and the non-terrestrial communication device 120 of FIG. 7 correspond to the user device 110 and the non-terrestrial communication device 120 of FIG. 4, respectively.

The user device 110 may transmit a first RRC setup request signal SR1 among the M number of RRC setup request signals SR1 to SRM included in the third message Msg3 to the non-terrestrial communication device 120 at the fourth time point T4. Subsequently, the user device 110 may sequentially transmit the second RRC setup request signal SR2 to the M-th RRC setup request signal SRM to the non-terrestrial communication device 120. The user device 110 may transmit the M-th RRC setup request signal SRM, corresponding to the last RRC setup request signal of the M number of RRC setup request signals SR1 to SRM, to the non-terrestrial communication device 120 at the fifth time point T5.

The user device 110 may set the power management device to the second discontinuous reception (DRX2) mode during the third time interval f3. The third time interval f3 may indicate a time interval between a fifth time point T5 and a 5a-th time point T5a at which the fourth time interval f4 starts. In other words, the user device 110 may perform a discontinuous reception operation under the control of the power management device during the third time interval f3. Accordingly, the user device 110 may suppress power consumption during the third time interval f3.

The third time interval f3 may indicate a round trip time interval between the user device 110 and the non-terrestrial communication device 120. Specifically, the third time interval f3 may be determined based on a time required to transmit the third message Msg3 from the user device 110 to the non-terrestrial communication device 120 and a time required to transmit the fourth message Msg4 from the non-terrestrial communication device 120 to the user device 110. Since the non-terrestrial communication system has a long distance between the user device 110 and the non-terrestrial communication device 120, a time required for the user device 110 to transmit the third message Msg3 and receive a response signal (e.g., the fourth message Msg4) corresponding to the third message Msg3 may be considered as a time interval for performing the discontinuous reception operation.

According to some embodiments, the third sub-interval f3 may correspond to the ‘UE-eNB-RTT’ defined in the 3GPP standard.

According to some embodiments, the third sub-interval f3 is determined based on the first correction time and the second correction time. For example, the second sub-interval f12 may be the sum of the first correction time and the second correction time. In this case, the first correction time and the second correction time may correspond to the first correction time and the second correction time of the second sub-interval f12 of FIG. 5, respectively.

The user device 110 may receive the fourth message Msg4 from the non-terrestrial communication device 120 at the sixth time point T6 which is an arbitrary time point during the fourth time interval f4. The fourth message Msg4 may include the random access response signal.

The fourth time interval f4 may indicate a time interval between a 5a-the time point T5a and a 6a-th time point T6a. The fourth time interval f4 is a time interval to receive the fourth message Msg4 and may also be referred to as a competition resolution timer section.

According to some embodiments, the fourth time interval f4 may correspond to a contention resolution timer defined in the 3GPP standard.

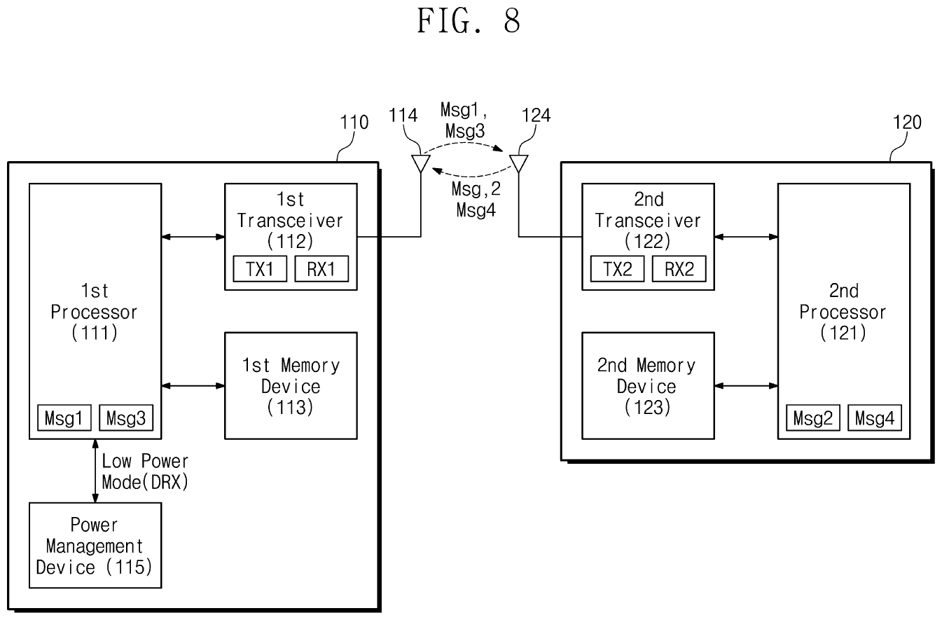

FIG. 8 is a block diagram illustrating the user device 110 and the non-terrestrial communication device 120 in a non-terrestrial network system according to some embodiments of the present disclosure. The user device 110 and the non-terrestrial communication device 120 of FIG. 8 correspond to the user device 110 and the non-terrestrial communication device 120 of FIG. 4, respectively.

The user device 110 may include a first processor 111, a first transceiver 112, a first memory device 113, a first antenna 114, and a power management device 115.

The first processor 111 may perform a random access procedure to access the data network through the non-terrestrial communication device 120. The first processor 111 may generate the first message Msg1, and may transmit the first message Msg1 to the first transceiver 112. The first processor 111 may generate the third message Msg3 based on the second message Msg2, and may transmit the third message Msg3 to the first transceiver 112.

In addition, the first processor 111 may set the power management device 115 to the discontinuous reception (DRX) mode.

For example, the first processor 111 may set the power management device 115 to the first discontinuous reception (DRX1) mode between the first time point at which the first transceiver 112 transmits the last random access preamble among the plurality of random access preambles contained in the first message Msg1 and the second time point at which the reception window interval for the second message Msg2 starts.

According to some embodiments, in the first discontinuous reception (DRX1) mode, the user device 110 may not monitor the second message Msg2.

According to some embodiments, in the first discontinuous reception (DRX1) mode, the user device 110 may perform a discontinuous reception (DRX) operation defined in the 3GPP standard.

For an example, the first processor 111 may set the power management device 115 to the second discontinuous reception (DRX2) mode between the third time point at which the first transceiver 112 transmits the last RRC setup request signal among the plurality of RRC setup request signals contained in the third message Msg3 and the fourth time point at which the contention resolution timer time interval for the fourth message Msg4 starts.

According to some embodiments, in the first discontinuous reception (DRX1) mode, the user device 110 may not monitor the second message Msg2.

According to some embodiments, in the first discontinuous reception (DRX1) mode, the user device 110 may perform a discontinuous reception (DRX) operation defined in the 3GPP standard.

According to some embodiments, the first processor 111 may identify the type of the random access procedure.

For example, the first processor 111 may determine whether the random access procedure is a random access requiring an RRC setup request signal. Specifically, the first processor 111 may determine whether the random access procedure is a CBRA or a CFRA. The first processor 111 may generate the third message Msg3 based on the determination that the random access procedure is a random access procedure requiring an RRC setup request signal.

For an example, the first processor 111 may determine whether the random access procedure is for initial random access, handover, or scheduling. Unlike the random access procedure for initial random access or handover, the user device 110 receives an UL-grant corresponding to resources allocation being completed, from the non-terrestrial communication device 120 to terminate the random access procedure, in the random access procedure for scheduling. Accordingly, the user device 110 may not set the power management device 115 to the DRX mode.

Specifically, the first processor 111 may set the power management device 115 to the first discontinuous reception (DRX1) mode during the first communication wait interval and to the second discontinuous reception (DRX2) mode during the second communication wait interval, based on the determination that the random access procedure is a random access (e.g., CBRA) requiring an RRC setup request signal.

In contrast, the first processor 111 may set the power management device 115 to the first discontinuous reception (DRX1) mode during the first communication wait interval and may not set the power management device to the second discontinuous reception (DRX2) mode during random access, based on the determination that the random access procedure is a random access (e.g., CFRA) which does not require an RRC setup request signal.

In addition, when the random access procedure is determined as being a random access procedure for scheduling, the first processor 111 may not set the power management device 115 to the discontinuous reception (DRX) mode during the random access procedure.

The first transceiver 112 may include a first transmitter TX1 and a first receiver RX1.

The first transmitter TX1 may receive the first message Msg1 and the third message Msg3 from the first processor 111. The first transmitter TX1 may transmit the first message Msg1 and the third message Msg3 to the non-terrestrial communication device 120 through the first antenna 114.

The first receiver RX1 may receive the second message Msg2 and the fourth message Msg4 from the non-terrestrial communication device 120 through the first antenna 114. The first receiver RX1 may transmit the second message Msg2 and the fourth message Msg4 received from the non-terrestrial communication device 120 to the first processor 111.

The first memory device 113 may communicate with the first processor 111. The first memory device 113 may store data or provide data to the first processor 111 in response to the request of the first processor 111.

The user device 110 may wirelessly communicate with the non-terrestrial communication device 120 using the first antenna 114.

The power management device 115 may manage power consumption of the user device 110. The power management device 115 may be set to the discontinuous reception (DRX) mode by the first processor 111. Based on the setting to the discontinuous reception (DRX) mode, the power management device 115 may control the user device 110 not to monitor reception of an arbitrary signal from the non-terrestrial communication device 120.

For example, the power management device 115 may control the user device 110 not to monitor the second message Msg2, in the first discontinuous reception (DRX1) mode.

For an example, the power management device 115 may control the user device 110 not to monitor the fourth message Msg4, in the second discontinuous reception (DRX2) mode.

For convenience of explanation, the first processor 111 and the power management device 115 are illustrated as separate components, and in the above description, the first processor 111 sets the power management device 115 to a discontinuous reception (DRX) mode to perform the discontinuous reception (DRX) operation. The scope of the present disclosure is not limited thereto. The user device 110 may not use a separate power management device 115, but the first processor 111 or another component may directly control the user device to perform the discontinuous reception operation defined in the 3GPP standard.

The non-terrestrial communication device 120 may include a second processor 121, a second transceiver 122, a second memory device 123, and a second antenna 124.

The second processor 121 may receive the first message Msg1 and the third message Msg3 from the second transceiver 122. The second processor 121 may generate the second message Msg2 based on the first message Msg1. The second processor 121 may generate the fourth message Msg4 based on the third message Msg3. The second processor 121 may transmit the second message Msg2 and the fourth message Msg4 to the second transceiver 122.

The second transceiver 122 may include a second transmitter TX2 and a second receiver RX2.

The second transmitter TX2 may receive the second message Msg2 and the fourth message Msg4 from the second processor 121. The second transmitter TX2 may transmit the second message Msg2 and the fourth message Msg4 to the user device 110 through the second antenna 124.

The second receiver RX2 may receive the first message Msg1 and the third message Msg3 from the user device 110 through the second antenna 124. The second receiver RX2 may transmit the first message Msg1 and the third message Msg3 to the second processor 121.

The second memory device 123 may store data or provide data to the second processor 121, in response to a request from the second processor 121.

The non-terrestrial communication device 120 may wirelessly communicate with the user device 110 using the second antenna 124.

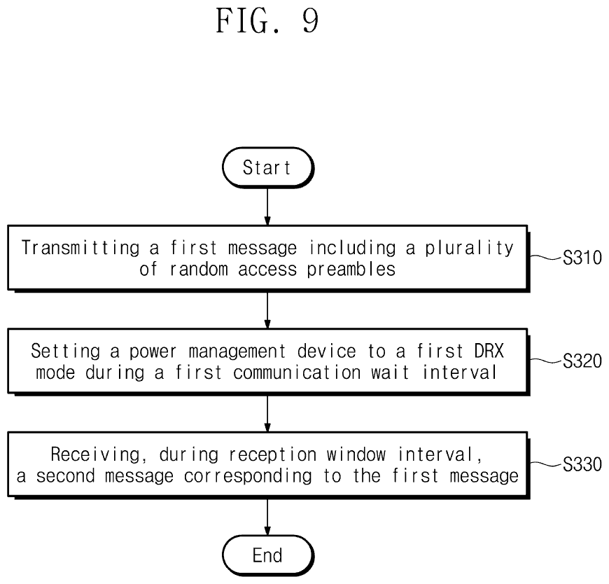

FIG. 9 is a flowchart illustrating a method for operating a user device according to some embodiments of the present disclosure. The following description will be made with reference to FIG. 9, regarding the method of operating the user device. The user device 110 of FIG. 9 corresponds to the user device 110 of FIG. 4.

In step S310, the user device may transmit the first message including the plurality of random access preambles to the non-terrestrial communication device.

According to some embodiments, each of the plurality of random access preambles may correspond to a random access preamble defined in the 3GPP standard.

In step S320, the user device may set the power management device to the first discontinuous reception (DRX1) mode during the first communication wait interval.

Specifically, the first communication wait interval may indicate a time interval between the first time point at which the user device transmits the last random access preamble among the plurality of random access preambles and the second time point at which the reception window interval starts.

According to some embodiments, when the power management device is set to the first discontinuous reception (DRX1) mode, the user device may not monitor the second message.

According to some embodiments, the first discontinuous reception (DRX1) mode may indicate that the user device performs an operation corresponding to a discontinuous reception operation defined in the 3GPP standard.

In step S330, the user device may receive the second message corresponding to the first message from the non-terrestrial communication device during the reception window interval.

According to some embodiments, the reception window interval may correspond to a random access response window size defined in the 3GPP standard.

According to an embodiment of the present disclosure, there are provided the user device performing discontinuous reception in a wireless communication system and the method of operating the same.

Furthermore, there may be provided the user device performing discontinuous reception in the wireless communication system and the method of operating the same, capable of performing the discontinuous reception operation for the communication wait interval without actually transmitting or receiving data between the user device (e.g., user equipment) and the non-terrestrial communication device (e.g., a satellite) during the random access, thereby maintaining communication performance while reducing power consumption.

The above description refers to detailed embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to exemplary embodiments thereof, it will be apparent to those of ordinary skill in the art that various changes and modifications may be made thereto without departing from the spirit and scope of the present disclosure as set forth in the following claims.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of operating a user device wirelessly communicating with a non-terrestrial communication device, the method comprising:
transmitting a first message including a plurality of random access preambles to the non-terrestrial communication device;
setting a power management device of the user device to a first discontinuous reception mode, during a first communication wait interval between a first time point, at which a last random access preamble among the plurality of random access preambles is transmitted, and a second time point at which a reception window interval starts; and
receiving a second message corresponding to the first message from the non-terrestrial communication device, during the reception window interval.

2. The method of claim 1,
wherein the user device is configured to be prevented from monitoring the second message, during the first communication wait interval.

3. The method of claim 1,
wherein the user device is configured to perform a discontinuous reception (DRX) operation defined in a 3^{rd} generation partnership project (3GPP) standard, during the first communication wait interval.

4. The method of claim 1,
wherein the first communication wait interval includes a first sub-interval and a second sub-interval,
wherein the first sub-interval is determined based on the plurality of random access preambles, and
wherein the second sub-interval is determined based on a correction time based on a distance between the user device and the non-terrestrial communication device.

5. The method of claim 4,
wherein the first sub-interval is determined based on a communication mode between the user device and the non-terrestrial communication device, a preamble format of the plurality of random access preambles, and the number of the plurality of random access preambles.

6. The method of claim 4,
wherein the correction time corresponds to ‘UE (user equipment)-eNB (evolved UTRAN node B)-RTT (round trip time)’ defined in a 3GPP standard.

7. The method of claim 1, further comprising:
transmitting, to the non-terrestrial communication device, a third message including a plurality of radio resource control (RRC) setup request signals, based on the second message;
setting the power management device to a second discontinuous reception mode, during a second communication wait interval between a third time point, at which a last RRC setup request signal among the plurality of RRC setup request signals is transmitted, and a fourth time point at which a contention resolution timer starts; and
receiving a fourth message corresponding to the third message from the non-terrestrial communication device, during the contention resolution timer interval.

8. The method of claim 7,
wherein the user device is configured to:
be prevented from monitoring the fourth message, during the second communication wait interval.

9. The method of claim 7,
wherein the user device is configured to:
perform a discontinuous reception (DRX) operation defined in a 3GPP standard, during the second communication wait interval.

10. The method of claim 7,
wherein the second communication wait interval is determined based on a correction time based on a distance between the user device and the non-terrestrial communication device.

11. The method of claim 10,
wherein the correction time corresponds to ‘UE (user equipment)-eNB (evolved UTRAN node B)-RTT (round trip time)’ defined in a 3GPP standard.

12. The method of claim 7,
wherein each of the plurality of RRC setup request signals corresponds to an RRC setup request signal defined in a 3GPP standard.

13. The method of claim 1,
wherein the user device and the non-terrestrial communication device support a 3GPP standard.

14. The method of claim 1,
wherein each of the plurality of random preambles corresponds to a random preamble defined in a 3GPP standard, and
wherein the second message corresponds to a random access response defined in the 3GPP standard.

15. The method of claim 1, further comprising:
activating connection of the user device to the non-terrestrial communication device.

16. A user device comprising:
a power management device;
a processor configured to generate a first message including a plurality of random access preambles;
a transceiver configured to transmit the first message to a non-terrestrial communication device and to receive a second message corresponding to the first message from the non-terrestrial communication device,
wherein the processor is configured to set the power management device to a first discontinuous reception mode, during a first communication wait interval between a first time point, at which the transceiver transmits a last random access preamble among the plurality of random access preambles, and a second time point at which a reception window interval during which the transceiver is allowed to receive the second message starts.

17. The user device of claim 16,
wherein the power management device is configured to prevent the user device from monitoring the second message, during the first communication wait interval.

18. The user device of claim 16, wherein the processor is configured to:
determine whether a radio resource control (RRC) setup request for the non-terrestrial communication device is required.

19. The user device of claim 18,
wherein the processor is configured to allow the transceiver to transmit, to the non-terrestrial communication device, a third message including a plurality of RRC setup request signals, based on the second message, in response to determining the RRC setup request as being required for the non-terrestrial communication device, and to receive a fourth message corresponding to the third message from the non-terrestrial communication device.
wherein the processor is configured to set the power management device to a second discontinuous reception mode, during a second communication wait interval between a third time point, at which a last RRC setup request signal among the plurality of RRC setup request signals is transmitted, and a fourth time point at which a contention resolution timer interval for receiving the fourth message starts.

20. A method of operating a non-terrestrial network system including a user device and a non-terrestrial communication device, the method comprising:
transmitting, by the user device, a first message including a plurality of random access preambles to the non-terrestrial communication device;
setting, by the user device, a power management device of the user device to a first discontinuous reception mode, during a first communication wait interval between a first time point, at which a last random access preamble among the plurality of random access preambles is transmitted, and a second time point at which a reception window interval starts; and
transmitting, by the non-terrestrial communication device, the second message corresponding to the first message to the user device, such that the user device receives the second message during the reception window interval, through the non-terrestrial network.
